(19) United States
(12) Patent Application Publication
(10) Pub. No.: US 2007/0244580 A1
(43) Pub. Date: Oct. 18, 2007

(54) Printing System and Interface Device Therefor

(76) Inventors: Adam Jude Ahne, Lexington, KY (US); Najib Bahous, Lexington, KY (US); Christopher Keith Caspar, Shelbyville, KY (US); Barry Richard Cavill, Versailles, KY (US); Aaron Michael Garvey, Lexington, KY (US); Mark Eric Miller, Versailles, KY (US); Robert Anthony Morris, Lexington, KY (US); Steven Andrew Rice, Shelbyville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/279,792

(22) Filed: Apr. 14, 2006

(51) Int. Cl. G05B 15/00

(52) U.S. Cl. 700/83

(57) ABSTRACT

A printing system includes a host having a virtual printer driver for converting a print job to a JPEG print file. A memory device is configured to receive the JPEG print file from the virtual printer driver. An imaging apparatus has a PictBridge port configured for receiving input from a camera. An interface device includes an important port, an export port and a processor device. The import port is configured for coupling to the memory device. The export port is configured for coupling to the PictBridge port of the imaging apparatus. The processor device is coupled to each of the input port and the export port. The processor device is configured to export the JPEG print file via the export port to the PictBridge port of the imaging apparatus.

### CROSS REFERENCES TO RELATED APPLICATIONS

None

### STATEMENT REGARDING FEDERALLY SPONSORED RESEARCH OR DEVELOPMENT

None

### REFERENCE TO SEQUENTIAL LISTING ETC.

None

### BACKGROUND

1. Field of the Invention

The present invention relates generally to printing, and more particularly to a printing system and an interface device therefor.

2. Description of the Related Art

In prior art, a printing system is typically formed by connecting a host, such as a personal computer, to a serial or parallel port on a printer. The connection may be made, for example, via a handwired or wireless connection. It is not uncommon for computer users to have multiple computers and one printer. Ideally, all of the computers will be connected in either a wired or a wireless network so they can share the printer.

However, many users do not network their computers because of the cost or complexity of installing a network. Also, it may not be convenient for a user to print to an unfamiliar printer, or to transport and print a print job at a remote printer location.

### SUMMARY OF THE INVENTION

The invention, in accordance with one embodiment, is directed to a printing system. The printing system includes a host configured for running an application, and having a virtual printer driver for converting a print job generated by the application to a JPEG print file. A memory device is configured to receive the JPEG print file from the virtual printer driver. An imaging apparatus has a print engine, a PictBridge port, and a controller communicatively coupled between the PictBridge port and the print engine. The PictBridge port is configured for receiving input from a camera. An interface device includes an import port, an export port and a processor device. The import port is configured for coupling to the memory device. The export port is configured for coupling to the PictBridge port of the imaging apparatus. The processor device is coupled to each of the import port and the export port. The processor device is configured to export the JPEG print file via the export port to the PictBridge port of the imaging apparatus.

The invention, in accordance with another embodiment, a directed to a printing system including a host computer and an imaging apparatus having a PictBridge port for receiving data from a camera. Means is provided for converting a print job generated by an application running on the host computer to a JPEG print file. Means is provided for exporting the JPEG print file to the PictBridge port of the imaging apparatus for printing.

The invention, in accordance with another embodiment, is directed to an interface device configured to facilitate communication of a JPEG print file representing a print job generated by an application running on a computer to an imaging apparatus having a PictBridge port. The interface device includes an import port, an export port, and a processor device. The import part is configured for receiving the JPEG print file. The export port is configured for coupling to the PictBridge port of the imaging apparatus. The processor device is coupled to each of the import port and the export port, the processor device being configured to export the JPEG print file via the export port to the PictBridge port of the imaging apparatus.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of an exemplary embodiment of the present invention;

FIG. 2 is a diagrammatic representation of another exemplary embodiment of the present invention; and

FIG. 3 is a diagrammatic representation of another exemplary embodiment of the present invention.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,”“coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configuration are possible.

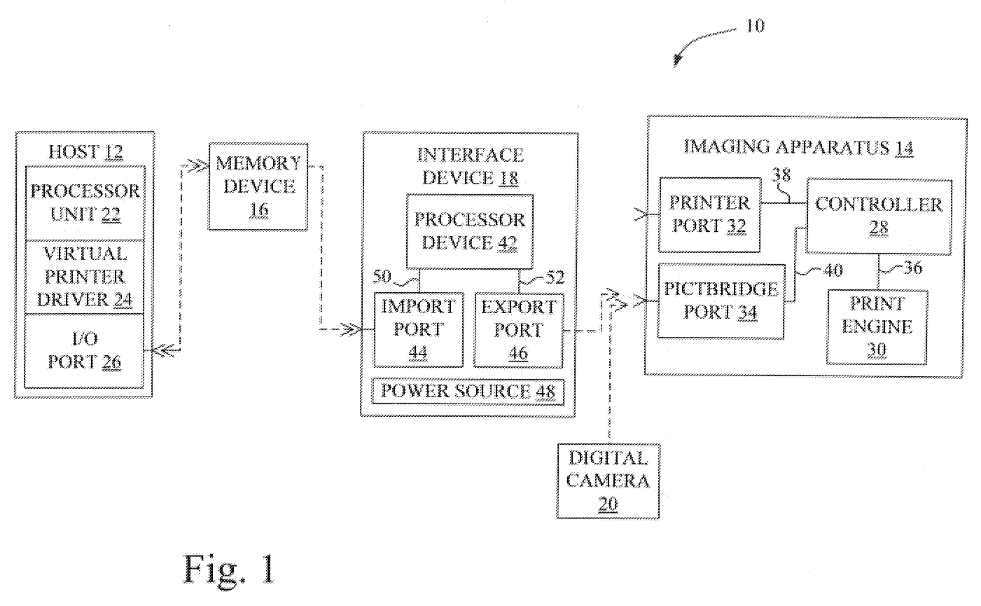

Referring now to FIG. 1, there is shown a printing system 10 in accordance with one exemplary embodiment of the present invention. Printing system 10 includes a host 12, an imaging apparatus 14, a memory device 16, and an interface device 18. Also shown as optional is a digital camera 20.

Host 12 includes a processor unit 22, a virtual printer driver 24 and an input/output (I/O) port 26. Host 12 may be, for example, a personal computer including, for example, a keyboard and display monitor. Processor unit 22 of host 12 may include, for example, one or more microprocessors and associated memory, such as RAM, ROM, NVRAM, and a mass data storage device, such as a hard drive, CD-ROM and/or DVD units.

Host 12 is configured via hardware, firmware and/or software for running an application, e.g., a computer program, on an operating system platform, such as WINDOWS® available from Microsoft Corporation. The application may generate print jobs which may be sent to a selected printer driver. A printer driver takes the print job and typically converts the print data into a format compatible with a printer selected to perform the printing operation.

With the present invention, the list of selectable printer drivers available to a user includes virtual printer driver 24. In some embodiments, for example, host 12 may upload virtual printer driver 24 from a partitioned section of memory device 16 containing an electronic copy of virtual printer driver 24, if virtual printer driver 24 does not already reside on host 12.

Virtual printer driver 24 does not convert the print job to a format corresponding to a particular printer, but rather, converts the print job into a JPEG format file, hereafter, a JPEG print file. As such, virtual printer driver 24 may be in the form of software or firmware that includes a set of program instructions for converting a print job generated by the application to a JPEG print file. The term JPEG print file is intended to include both single and plural JPEG files.

The file filename for each JPEG file begins with a distinctive header, such as $$LEX_SPOOL$$. A new JPEG file may be created for each page of the print job with the header defined such that the files can be associated with a specific print job, and with each page in sequence within that print job. For example, the job might be identified as $$LEX_SPOOLXXNNNN, where XX identifies the job number and NNNN identifies the page number. Alternatively, virtual printer driver 24 may create a batch control file definition similar to a DPOF (Digital Print Order format) file with the distinctive header. The control file will specify the JPEG files associated with a particular print job.

Information as to how the user wishes the output pages printed within a job (page size, paper type, print quality, etc.) may be included as part of the control file or within a separate file definition that is included along with the distinctively identified JPEG files.

Virtual printer driver 24 may include instructions that allow a user to adjust the resolution, and thus the file size, of each print job. Alternatively, if file size is not an issue, virtual printer driver 24 may store a low resolution and a high resolution JPEG file for each print job, and a switch may be provided on interface device 18 to select the print resolution.

Memory device 16 is configured to be communicatively coupled to virtual printer driver 24 for receiving the JPEG print file from virtual printer driver 24 and for storing the JPEG print file. Memory device 16 may enumerate, i.e., register, with host 12 as a mass storage device. Memory device 16 may be, for example, a removably attachable memory card or stick serving as a portable mass storage device, and may be in the form of semiconductor memory, such as a non-volatile random access memory (NVRAM), erasable programmable read-only memory (EPROM), or Flash Memory, i.e., a form of EEPROM (electrically-erasable programmable read-only memory). The storage capacity of memory device 16 may be determined based on the application, and as semiconductor memory may have a large storage capacity, e.g., one gigabyte, or higher. Memory device 16 may include a standard connector, such as a USB connector serving as an input/output (I/O) port, to facilitate direct physical connection, for example, to host 12 or interface device 18.

Once the user has placed one or more print jobs in memory device 16, the user may unplug memory device 16 from host 12, and plug memory device 16 into interface device 18, which in turn is plugged into imaging apparition 14. Interface device 18 may be configured, via hardware, firmware, and/or software, to recognize the files with distinctive header and/or control files. The interface device 18 so configured would then examine any included control or print output definition files and use this information to choose the closest PictBridge configuration settings that are supported by the attached imaging apparatus 14. The interface device 18 would then search memory device 16 for any distinctive JPEG files and automatically print them. Also interface device 18 if so configured, would search for control files and print the specified JPEG files identified within the control files.

Each JPEG print file may be deleted from memory device 16 after the file has been successfully printed by imaging apparatus 14. Thus, memory device 16 acts as a detachable print spooler for imaging apparatus 14. Alternatively, interface device 18 may mark the JPEG files to printed and virtual printer driver 24 will delete the printed files. Virtual printer driver 24 may also prompt the user as to whether to delete the marked files.

Imaging apparatus 14 includes a controller 28, a print engine 30, a printer port 32, and a PictBridge port 34. Imaging apparatus 14 may also include an operator panel (not shown). Imaging apparatus 14 may be, for example, any printing device such as color and black-and-white copiers, color and black-and-white printers, and so-called “all-in-one devices” that incorporate multiple functions such as scanning copying, and printing capabilities in one device. Controller 28 is communicatively coupled to print engine 30 via a communications link 36, to printer port 32 via a communications link 38, and to PictBridge port 34 via a communications link 40. As used herein, the term communications link is any suitable wired and/or wireless connections between two or more components or devices.

Controller 28 may include, for example, a microprocessor unit and associated memory, and may be formed as an Application Specific Integrated Circuit (ASIC). Controller 28 executes program instructions to perform predefined tasks, such as for example, retrieving JPEG files via PictBridge Port 34, converting the JPEG files to formatted print data, and sending the formatted print data to print engine 30. Print engine 30 is configured to generate a printed output based on the formatted print data, and may utilize any of ink jet, dot matrix, dye sublimation, electrophotographic (e.g., laser), or any other suitable print technologies.

Data intended for printing may be received from an external device, such as host 12, via printer port 32 in an manner well know in the art, e.g., via a parallel or serial connection and an associated communication protocol. In addition, however, imaging apparatus 14 includes PictBridge port 34. PictBridge is an industry standard from the Camera & Imaging Products Association (CIPA) that allows images to be printed directly from digital cameras on a printer so equipped, without having to connect the camera to a computer. Accordingly, PictBridge port 34 of imaging apparatus 14 is configured under the predefined standard for receiving input from a camera, such as digital camera 20, and permits printing of photographs downloaded from digital camera 20, with the aid of at least some user intervention, without requiring connection to host 12.

Interface device 18 may be configured and constructed as a portable device. Interface device 18 includes a processor device 42, an import port 44, an import port 44, an export port 46 and a power source 48. Each of import port 44 and export port 46 may be in the form of a bi-directional communications interface, e.g., a universal serial bus (USB) port. Power source 48 may be, for example, a battery, or circuitry to provide a connection to an external power source, such as imaging apparatus 14, and supplies electrical power to the circuitry associated with processor device 42, import port 44, export port 46, and/or memory device 16 (when installed). It is also contemplated that interface device 18 may be a USB bus powered device.

Processor device 42 is communicatively coupled to import port 44 via a communication link 50 and to export port 46 via communication link 52. Import port 44 is configured for coupling to memory device 16, and export port 46 is configured for coupling to PictBridge port 34 of imaging apparatus 14. In one embodiment, for example, interface device 18 is configured such that it will not communicate with imaging apparatus 14 if memory device 16 is not plugged into import port 44 of interface device 18, or if memory device 16 does not contain any JPEG files to be printed, so as to not unduly the up imaging apparatus 14. Input port 44 may be configured to enumerate to host 12 as a mass storage device. Export port 46 may be configured to enumerate to imaging apparatus 14 as a PictBridge device.

Processor device 42 is configured, e.g., via hardware, firmware and/or software, to export the JPEG print file from memory device 16 via export port 46 to PictBridge port 34 of imaging apparatus 14. Controller 28 converts the JPEG print file to the specific print data format required by print engine 30 for printing. When the export port 46 of interface device 18 is physically connected to PictBridge port 34 of imaging apparatus 14, information in a control file or without a separate file definition is used along with PictBridge capability information received from the imaging apparatus 14 to choose the PictBridge configuration settings for the print job. The JPEG files identified by the processor device 42 are then exorted to the imaging apparatus automatically beginning printing without user intervention.

In one embodiment , for example, interface device 18 may look for JPEG files on the coupled memory device 16 that have the distinctive header and cause imaging apparatus 14 to automatically print these files. Processor device 42 of interface device 18 may control imaging apparatus 14 by sending PictBridge commands to initiate printing and transfer the JPEG files from memory device 16 to PictBridge port 34 of imaging apparatus 14. PictBridge printers by definition support printing JPEG files and can be controlled by a camera, such as digital camera 20. Accordingly, interface device 18 emulates a digital camera and will work with any PictBridge capable printer.

Thus, from the standpoint of imaging apparatus 14, interface device 18 appears as if it is a digital camera. As a result, the JPEG print file stored on memory device 16 may be easily exported via interface device 18 and PictBridge port 34 to imaging apparatus 14, in the absence of host 12, for automatic printing by print engine 30 with no user intervention. Such a feature is particularly useful if, for example, a user is traveling and has a print job that needs to be printed and the user has access to a printer having a PictBridge port, but the operating instructions associated with the printer are in a language foreign to the user. In such as ease, the user need only install interface device 18 with memory device 16 on the PictBridge port of the printer, and printing occurs automatically.

Some PictBridge printers may not support printing of the output at the original size specified by virtual printer driver 24. In this case, processor device 42 of interface device 18 will determine the print sizes supported by the printer and then specify scaling of the printed page to the closest output size. The user may be notified through an optional error indicator on interface device 18 or interface device 18 may create an error indication on imaging apparatus 14 by sending an unsupported size definition. Canceling may be accomplished by removing interface device 18, removing memory device 16, or by addition of an optional button on interface device 18.

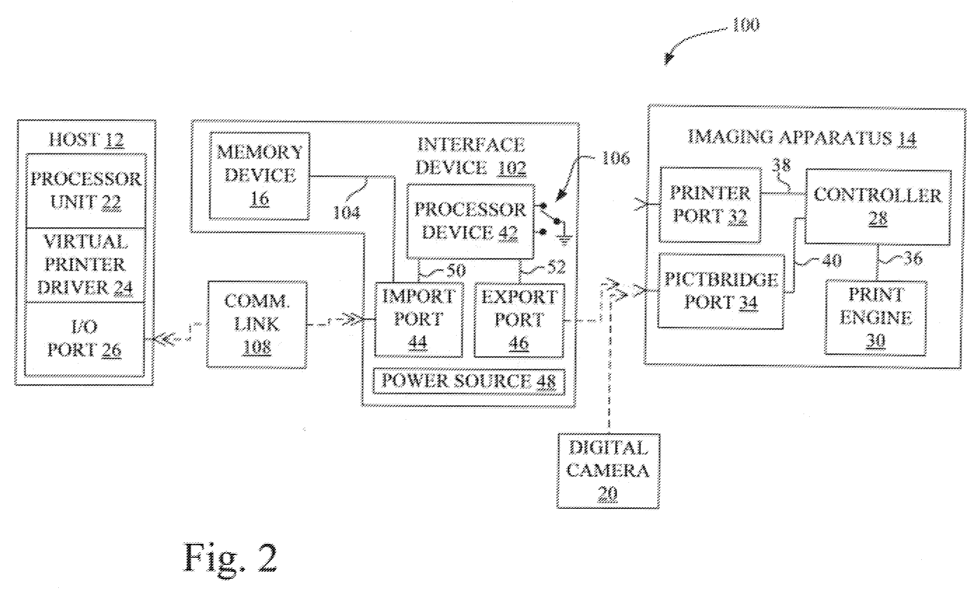

FIG. 2 shows a printing system 100 in accordance with another exemplary embodiment of the present invention. Both host 12 and imaging apparatus 14 are configured and operate as described above with respect to the embodiment of FIG. 1, and for brevity will not be repeated here. In the embodiment of FIG. 2, however, an interface device 102 replaces the interface device 18 of FIG. 1.

In this embodiment, memory device 16 may be integrated with interface driver 102 as a unitary module. Alternatively, however, interface device 102 may be configured for memory device 16 to be removably attachable. Memory device 16 is communicatively coupled to import port 44 via a communications link 104. Interface device 102 may further include a switch 106.

Switch 106 is accessible to a user, and may be used to select a mode of operation of processor device 42, e.g., to select from a first mode of operation when memory device 16 is to receive the JPEG print file from host 12 and a second mode of operation when interface device 102 is to export the JPEG print file from memory device 16 to PictBridge port 34 of imaging apparatus 14. The switching between receiving data and output of files may alternately be selectable by software for firmware process. Alternatively, switch 106 may be used to enable automatic deletion of printed JPEG files.

When preparing to operate in the first mode of operation, for example, interface device 102 is communicatively coupled to host 12 via a communication link 108, and switch 106 is placed in a download position. The download position of switch 106 signals processor device 42 that host 12 will be supplying one or more JPEG files and potentially control/print definition files for storage in memory device 16.

Communication link 108 may be, for example, a wired connection or a wireless connection, and may include intermediate devices, such as, for example, signal drivers, a transmitter, a receiver, etc.

When preparing to operate in the second mode of operation, interface device 102 is communicatively coupled to PictBridge port 34 of imaging apparatus 14, and switch 106 is placed in the output position. The export position of switch 106 signals processor device 42 that interface device 102 will be exporting the JPEG files to imaging apparatus 14 for printing by engine 30. The distinctive JPEG files (and/or control files) when present will be printed by print engine 30, automatically without user intervention, when export port 46 of interface device 102 is physically connected to PictBridge port 34 of imaging apparatus 14.

Interface device 102, including memory device 16, may be configured to enumerate with host 12 as a printer as well as a USB mass storage device to simplify the creation of a virtual printer port within Windows ®. Interface device 102 may also integrate the print port function. Also, interface device 102 may contain a user identification or serial number so that the shared printer can track supplies usage by a user so that, for example, users of a communal printer fairly share the cost of printing. For example, the communal printer may have a users list to prevent unauthorized accesses. The users can also identify themselves to the communal printer by typing in a user code or password.

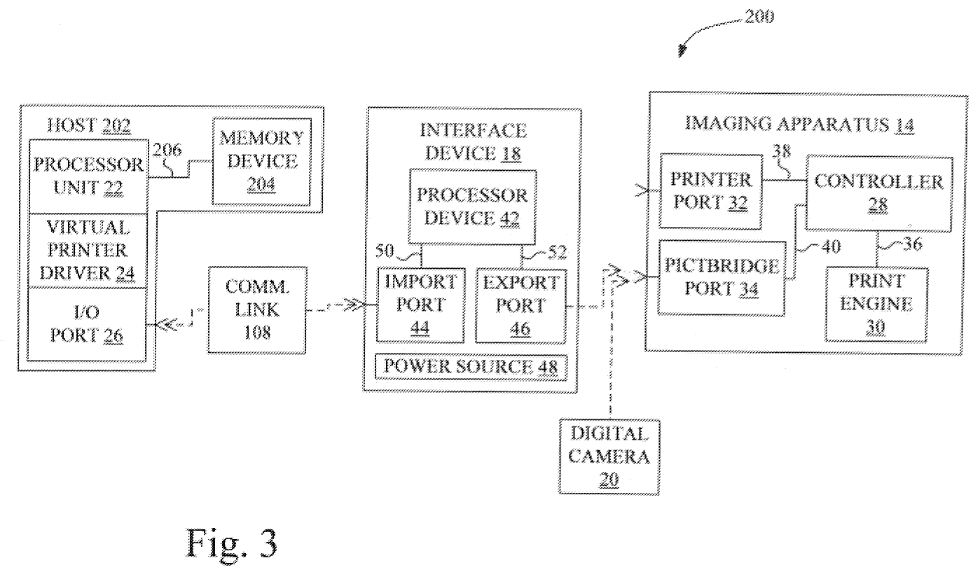

FIG. 3 shows a printing system 200 in accordance with another exemplary embodiment of the present invention. Both interface device 18 and imaging apparatus 14 are configured and operate as described above with respect to the embodiment of FIG. 1, and for brevity will not be repeated here. In the embodiment of FIG. 3, however, a host 202 replaces the host 12 of FIG. 1.

In this embodiment, a memory device 204 is integrated with host 202. Alternatively, however, host 202 may be configured for memory device 204 to be removably attachable, or alternatively, permanently attached. Memory device 204 is communicatively coupled to processor unit 22 via a communications link 206. In this embodiment, memory 204 may serve as a JPEG print job buffer, on a short term or long term storage basis, and may be in the form of semiconductor memory, if desired. Alternatively, memory device 204 may be in the form of a data pass-through register, e.g., a temporary data buffer, wherein a JPEG print file generated by virtual printer driver 24 merely passes through memory device 204 on its way to interface device 18.

Host 202 is configured via hardware, firmware and/or software for running an application, e.g., a computer program, on an operating system platform, such as WINDOWS® available from Microsoft Corporation. The application may generate print jobs which may be sent to a selected printer driver. When a user selects virtual printer driver 24, that print job is not converted to a format corresponding to a particular printer, but rather, converts the print job into a JPEG print file. Memory device 204 is configured to be communicatively coupled to virtual printer driver 24 for receiving the JPEG file from virtual printer driver 24 and for storing or pausing the JPEG print file.

When communications link 108 is established between host 202 and interface device 18, processor device 42 of interface device 18 signals processor unit 22 of host 202 that it is ready to receive a download of the distinctive JPEG files and optionally control and print settings files. When files are received, PictBridge communication with imaging apparatus 14 begins and the files are transferred via PictBridge to the imaging apparatus 14 for printing by the print engine 30. Printing of the JPEG files begins automatically without user intervention.

In the embodiments of FIGS. 2 and 3, communications link 108 may be a wireless interface, e.g., a wireless transmitter/receiver pair, implemented between I/O port 26, e.g., a USB port, of host 12 (202) and import port 44 of the interface device 102 (18). In such a case, communications link 108 removes the need to unplug the interface device 102 (18) from host 12 (202) when printing, while still enabling host 12 (202) to print to any PictBridge printer, such as imaging apparatus 14. In this embodiment, the application program running on host 12 (202) sends print data to virtual printer driver 24, which converts the print data into a JPEG print file, and communication link 108 moves the JPEG print file to interface device 102 (18), which in turn exports PictBridge commands and the JPEG print file to PictBridge port 34 of imaging apparatus 14.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A printing system, comprising:
a host configured for running an application, and having a virtual printer driver for converting a print job generated by said application to a JPEG print file;
a memory device configured to receive said JPEG print file from said virtual printer driver;
an imaging apparatus having a print engine, a PictBridge port, and a controller communicatively coupled between said PictBridge port and said print engine, said PictBridge port being configured for receiving input from a camera; and
an interface device including:
an import port configured for coupling to said memory device;
an export port configured for coupling to said PictBridge port of said imaging apparatus; and
a processor device coupled to each of said import port and said export port, said processor device being configured to export said JPEG print file via said export port to said PictBridge port of said imaging apparatus.

2. The printing system of claim 1, wherein each of an exporting of said JPEG print file to said imaging apparatus and a printing of said JPEG print file by said print engine occurs automatically when said export port of said interface device is physically connected to said PictBridge port of said imaging apparatus.

3. The printing system of claim 1, wherein said memory device enumerates to said host as one of, a mass storage device, a printer, and a combination of a mass storage device and printer.

4. The printing system of claim 1, wherein said memory device is a semiconductor memory module having a USB input/export port.

5. The printing system of claim 1, wherein said memory device is removably attachable to said interface device.

6. The printing system of claim 1, wherein said memory device is integrated with said interface device as a unitary module.

7. The printing system of claim 1, said interface device having a switch to select a mode of operation of said processor device from a first mode of operation when said memory device is to receive said JPEG print file from said host, and a second mode of operation when said interface device is to export said JPEG print file to said PictBridge port of said imaging apparatus.

8. The printing system of claim 1, said interface device having a switch coupled to said processor device to selectively enable deletion of said JPEG print file from said memory device.

9. The printing system of claim 1, wherein said host uploads said virtual printer driver from a portion of said memory device containing a copy of said virtual printer driver.

10. The printing system of claim 1, wherein said virtual printer driver specifies print instructions via a control file containing printing setup and JPEG file listings.

11. The printing system of claim 10, wherein information in said control file is converted to PictBridge configuration settings for printing of JPEG files.

12. The printing system of claim 1, wherein said memory device is integrated with said host and is communicatively coupled to said import port of said interface device via a communication link.

13. The printing system of claim 12, wherein said communication link is one of a wired connection and a wireless connection.

14. The printing system of claim 1, wherein said memory device is communicatively coupled to said interface device, and said import port of said interface device is communicatively coupled to said host via a communication link.

15. The printing system of claim 14, wherein said communication link is one of a wired connection and a wireless connection.

16. A printing system including a host computer and an imaging apparatus having a PictBridge port for receiving data from a camera, comprising:
means for converting a print job generated by an application running on said host computer to a JPEG print file; and
means for exporting said JPEG print file to said PictBridge port of said imaging apparatus for printing.

17. The printing system of claim 16, further comprising means to create a control or print definition file specifying settings for printing.

18. The printing system of claim 16, wherein each of said exporting of said JPEG print file to said imaging apparatus and said printing of said JPEG print file by said imaging apparatus occurs automatically when said means for exporting is physically connected to said PictBridge port of said imaging apparatus.

19. The printing system of claim 16, further comprising a removably attachable memory device for receiving said JPEG print file from said host and for storing said JPEG print file.

20. The printing system of claim 20, wherein said means for exporting is an interface device including:
an import port configured for coupling to said memory device;
an export port configured for coupling to said PictBridge port of said imaging apparatus; and
a processor device coupled to each of said import port and said export port, said processor device being configured to export said JPEG print file via said export port to said PictBridge port of said imaging apparatus.

21. The printing of claim 20, wherein said memory device is integrated with said interface device as a unitary module.

22. The printing system of claim 20, wherein said host computer is communicatively coupled to said interface device via a communication link, wherein said communication link is one of a wired connection and a wireless connection.

23. An interface device configured to facilitate communication of a JPEG print file representing a print job generated by an application running on a computer to an imaging apparatus having a PictBridge port, comprising:
an import port configured for receiving said JPEG print file;
an export port configured for coupling to said PictBridge port of said imaging apparatus; and
a processor device coupled to each of said import port and said export port, said processor device being configured to export said JPEG print file via said export port to said PictBridge port of said imaging apparatus.

24. The interface device of claim 23, further comprising a memory device configured for storing said JPEG print file.

25. The interface device of claim 24, wherein said memory device is removably attachable to said interface device.

26. The interface device of claim 23, further comprising a switch communicatively coupled to said processor, said switch selecting a mode of operation of said interface device.

27. The interface device of claim 23, wherein control file or print definition file information is converted to PictBridge configuration settings for printing of JPEG files by said imaging device.
